(19) United States
(12) Patent Application Publication
(10) Pub. No.: US 2025/0138261 A1
(43) Pub. Date: May 1, 2025

(54) OPTICAL MODULE AND OPTICAL RECEPTACLE

(71) Applicant: Enplas Corporation, Saitama (JP)

(72) Inventor: Ayano HINATA, Saitama (JP)

(21) Appl. No.: 18/926,374

(22) Filed: Oct. 25, 2024

(30) Foreign Application Priority Data
Oct. 30, 2023 (JP) 2023-185523

(51) Int. Cl. G02B 6/42

(52) U.S. Cl. CPC G02B 6/4246

(57) ABSTRACT

An optical module of the present invention includes a light receiving element, a light emitting element, an optical transmission body, and an optical receptacle for allowing reception light from an end surface of the optical transmission body to reach the light receiving element and for allowing transmission light from the light emitting element to reach the end surface of the optical transmission body. In the optical module, a principal ray of the reception light and a principal ray of the transmission light between a transmission reflection section and a first optical surface are located close to each other in a direction along an optical path between a second optical surface and the transmission reflection section as compared to an optical module for comparison.

### CROSS REFERENCE TO RELATED APPLICATIONS

This application is entitled to and claims the benefit of Japanese Patent Application No. 2023-185523, filed on Oct. 30, 2023, the disclosure of which including the specification, drawings and abstract is incorporated herein by reference in its entirety.

### TECHNICAL FIELD

The present invention relates to an optical module and an optical receptacle.

### BACKGROUND ART

An optical receptacle is known, which is for optically coupling light from an optical transmission body such as an optical fiber to a light receiving element disposed on a substrate and for optically coupling light from a light emitting element disposed on the substrate to the optical transmission body. A communication method using light to the light receiving element and light from the light emitting element through one optical transmission body as described is called bidirectional communication. In the bidirectional communication through the one optical transmission body, it is not necessary to use an optical transmission body for transmission and another optical transmission body for reception, and thus an apparatus can be simplified. For example, Patent Literature (hereinafter, referred to as PTL) 1 discloses an optical transmission module including an optical member (optical receptacle) that is used for the bidirectional communication through such one optical transmission body.

### CITATION LIST

### Patent Literature

### PTL 1

Japanese Patent Application Laid-Open No. 2009-251375

### SUMMARY OF INVENTION

### Technical Problem

FIG. 1 illustrates a cross-sectional outline of optical module 1 in the related art that is used in bidirectional communication as described above. Optical module 1 includes light receiving elements 20 and light emitting elements 30 disposed on substrate 10, optical receptacle 40, and optical transmission bodies 50.

Bidirectional communication in such optical module 1 is as follows. That is, reception light from optical transmission body 50 to light receiving element 20 enters the inside of optical receptacle 40 from first optical surface 41 of optical receptacle 40, is reflected by transmission reflection section 40a, is emitted from optical receptacle 40 through second optical surface 42, and reaches light receiving element 20. On the other hand, transmission light from light emitting element 30 to optical transmission body 50 enters the inside of optical receptacle 40 from third optical surface 43, is reflected by reflection section 44, passes through transmission reflection section 40a while being refracted, is emitted from optical receptacle 40 through first optical surface 41, and reaches an end surface of optical transmission body 50.

Here, it is preferable that the light from light emitting element 30 stably reaches optical transmission body 50. Accordingly, in order to allow the light from light emitting element 30 to stably reach the end surface of optical transmission body 50, the end surface of optical transmission body 50 may be inclined as illustrated in FIG. 1. When the end surface of optical transmission body 50 is inclined as described above, the transmission light from light emitting element 30 and emitted from first optical surface 41 is reflected at the end surface of optical transmission body 50 to return to light emitting element 30, namely so-called returning light, can be reduced, and therefore an operation of light emitting element 30 is stabilized.

Meanwhile, the present inventors have found that the following problems occur when the end surface of optical transmission body 50 is inclined. That is, when the end surface of optical transmission body 50 is inclined, light is likely to be refracted with respect to the end surface. Specifically, the transmission light is refracted when the transmission light is incident on the end surface of optical transmission body 50, and the reception light is refracted when the reception light emits from the end surface of optical transmission body 50.

As described above, light is refracted when the end surface of optical transmission body 50 is inclined, and due to this, the present inventors have found that it is difficult to align optical receptacle 40 with respect to light receiving element 20 and light emitting element 30 disposed on substrate 10. This will be described below with reference to FIGS. 2A and 2B.

FIG. 2A is a graph illustrating a change in coupling efficiency of the reception light and the transmission light with respect to a position deviation of optical receptacle 40 when the end surface of optical transmission body 50 is not inclined, and FIG. 2B is a graph illustrating a change in coupling efficiency of the reception light and the transmission light with respect to a position deviation of optical receptacle 40 when the end surface of optical transmission body 50 is inclined.

In FIGS. 2A and 2B, a solid line indicates a change in coupling efficiency of the reception light when optical receptacle 40 is moved in the Z direction, with the center of second optical surface 42 aligned with respect to the center of light receiving element 20 as a reference (movement amount 0 μm), and a dashed line indicates a change in coupling efficiency of the transmission light when optical receptacle 40 is moved in the Z direction, with the center of third optical surface 43 aligned with respect to the center of light emitting element 30 as a reference (movement amount 0 μm). In FIGS. 2A and 2B, the coupling efficiency is represented as a curved line that is convex upward, and a top portion of the curved line has a substantially linear portion in which the coupling efficiency does not substantially change even when a movement distance changes.

The substantially linear portion relates to a position deviation tolerance range when optical receptacle 40 is aligned with respect to light receiving element 20 and light emitting element 30 disposed on substrate 10.

Specifically, from the viewpoint of widening the position deviation tolerance range, it is preferable that optical receptacle 40 is designed such that the length of the linear portion is increased. Further, from the viewpoint of preventing the coupling efficiency from decreasing even when the position deviation occurs in any one direction of two directions along the Z-axis, it is preferable that optical receptacle 40 is designed such that the change in the coupling efficiency is the same regardless of whether the movement is performed in the + direction or in the − direction in the graph. That is, it is preferable that the midpoint (hereinafter, also referred to as a tolerance center) of the substantially linear portion is located close to a line of the movement amount of 0 μm, and the curved line indicating the coupling efficiency is symmetrical with respect to the line of the movement amount of 0 μm as a reference.

Here, as can be understood from the comparison between FIGS. 2A and 2B, when the end surface of optical transmission body 50 is not inclined, the tolerance center is close to a line of the movement amount of 0 μm (see FIG. 2A). However, when the end surface of optical transmission body 50 is inclined, the tolerance center becomes farther away from the line of the movement amount of 0 μm (see FIG. 2B). For example, in the example illustrated in FIG. 2B, light receiving element 20 or light emitting element 30 with respect to optical receptacle 40 is vulnerable to position deviation in the + direction, and the coupling efficiency significantly decreases when the position deviation occurs in the + direction. Note that, FIGS. 2A and 2B are images for describing a change in the tolerance range, and numerical values and the like are provisional.

An object of the present invention is to provide an optical module and an optical receptacle used for the optical module each capable of preventing a tolerance range from being biased even when an end surface of an optical transmission body is inclined.

### Solution to Problem

The present invention relates to the following optical modules and an optical receptacle.

[1] An optical module comprising: a light receiving element; a light emitting element; an optical transmission body; and an optical receptacle for allowing reception light from an end surface of the optical transmission body to reach the light receiving element and for allowing transmission light from the light emitting element to reach the end surface of the optical transmission body,
wherein:
the optical receptacle includes: a first optical surface for allowing the reception light from the end surface of the optical transmission body to enter an inside of the optical receptacle and for emitting, toward the end surface of the optical transmission body, the transmission light having passed through the inside of the optical receptacle; a second optical surface for emitting, toward the light receiving element, the reception light having passed through the inside of the optical receptacle, or for allowing the transmission light from the light emitting element to enter the inside of the optical receptacle; a third optical surface for allowing the transmission light from the light emitting element to enter the inside of the optical receptacle, or for emitting, toward the light receiving element the reception light having passed through the inside of the optical receptacle, the third optical surface being disposed at a position farther from the first optical surface than the second optical surface is; and a transmission reflection section for reflecting, toward the second optical surface, the reception light having entered the inside of the optical receptacle through the first optical surface, and transmitting the transmission light having entered the inside of the optical receptacle through the third optical surface, or for reflecting, toward the first optical surface, the transmission light having entered the inside of the optical receptacle through the second optical surface, and transmitting the reception light having entered the inside of the optical receptacle through the first optical surface,
in a cross section including a central axis of the optical transmission body and parallel to an optical axis of the light emitting element, an end surface of the optical transmission body is inclined with respect to a surface perpendicular to the central axis of the optical transmission body, the end surface facing the first optical surface,
in the optical module, a principal ray of the reception light and a principal ray of the transmission light between the transmission reflection section and the first optical surface are located close to each other in a direction along an optical path between the second optical surface and the transmission reflection section, as compared to an optical module for comparison configured such that an optical axis of light emitted from the first optical surface coincides with the central axis of the optical transmission body, and
when a first intersection point is defined as an intersection point between the principal ray of the reception light and the first optical surface, a second intersection point is defined as an intersection point between the principal ray of the transmission light and the first optical surface, and the principal ray of the reception light, the principal ray of the transmission light,
the first intersection point, and the second intersection point are projected onto the cross section, the first intersection point and the second intersection point are located in one region among two regions separated from each other by an extension line of the central axis of the optical transmission body, and the first optical surface refracts the principal ray of the reception light and the principal ray of the transmission light such that the principal rays approach the extension line of the central axis of the optical transmission body.
   [2] The optical module according to [1], wherein the cross section includes an optical path between the first optical surface and the transmission reflection section and the optical path between the second optical surface and the transmission reflection section.
   [3] The optical module according to [1] or [2], wherein: on the cross section, a center of the first optical surface is located at a position such that the center does not overlap with the extension line of the central axis of the optical transmission body; and the central axis of the first optical surface is inclined such that the central axis approaches the extension line of the central axis of the optical transmission body as the central axis approaches the transmission reflection section.
   [4] The optical module according to any one of [1] to [3], wherein between the first optical surface and the transmission reflection section, the principal ray of the reception light and the principal ray of the transmission light overlap with each other.
   [5] The optical module according to any one of [1] to [4], wherein between the first optical surface and the transmission reflection section, the principal ray of the reception light and the principal ray of the transmission light are parallel to a bottom surface of the optical receptacle.
   [6] The optical module according to any one of [1] to [5], wherein the principal ray of the reception light or the transmission light between the second optical surface and the light receiving element or the light emitting element, and the principal ray of the transmission light or the reception light between the third optical surface and the light emitting element or the light receiving element are perpendicular to a bottom surface of the optical receptacle.
   [7] The optical module according to any one of [1] to [6], further comprising: a reflection section for reflecting, toward the transmission reflection section, the transmission light from the third optical surface, or for reflecting, toward the third optical surface, the reception light from the transmission reflection section, the reflection section being disposed on an optical path between the third optical surface and the transmission reflection section.
   [8] The optical receptacle used for the optical module according to any one of [1] to [7].

### Advantageous Effects of Invention

According to the present invention, it is possible to provide an optical module and an optical receptacle used for the optical module each capable of preventing a tolerance range from being biased even when an end surface of an optical transmission body is inclined.

### BRIEF DESCRIPTION OF DRAWINGS

FIG. 1 illustrates an optical module in the related art (for comparison);

FIGS. 2A and 2B are graphs for describing that a tolerance range of an optical receptacle is biased;

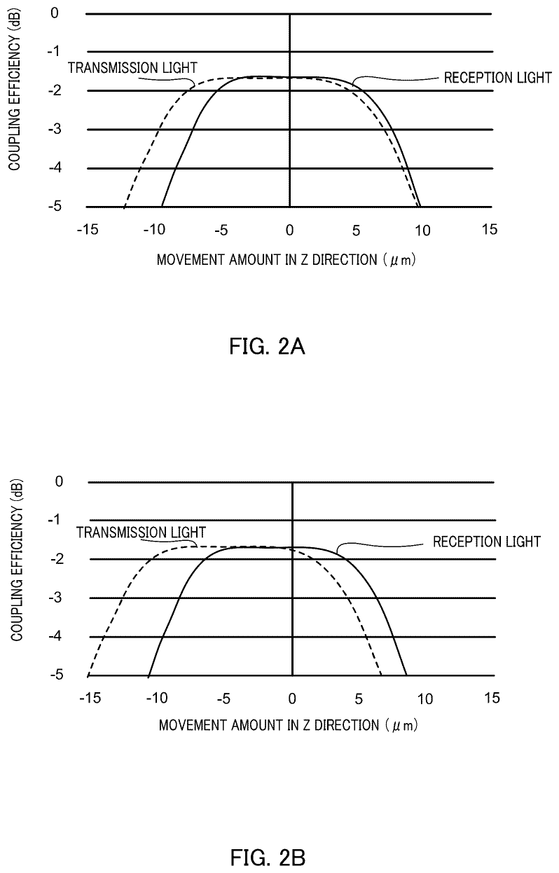

FIGS. 3A to 3D illustrate an optical module according to Embodiment 1;

FIGS. 4A and 4B illustrate the optical module according to Embodiment 1;

FIGS. 5A and 5B illustrate optical paths in the optical module according to Embodiment 1;

FIGS. 6A and 6B are graphs illustrating simulation results;

FIGS. 7A and 7B are graphs illustrating simulation results;

FIGS. 8A to 8D illustrate an optical module according to Embodiment 2;

FIGS. 9A and 9B illustrate the optical module according to Embodiment 2;

FIGS. 10A to 10D illustrate an optical receptacle according to Embodiment 3;

FIGS. 11A and 11B illustrate the optical receptacle according to Embodiment 3;

FIGS. 12A to 12D illustrate an optical module according to Embodiment 4;

FIGS. 13A and 13B illustrate the optical module according to Embodiment 4;

FIGS. 14A to 14D illustrate an optical receptacle according to Embodiment 5; and

FIGS. 15A and 15B illustrate the optical receptacle according to Embodiment 5.

### DESCRIPTION OF EMBODIMENTS

### Embodiment 1

### [Configuration of Optical Module]

Hereinafter, an optical module according to Embodiment 1 of the present invention will be described in detail with reference to drawings.

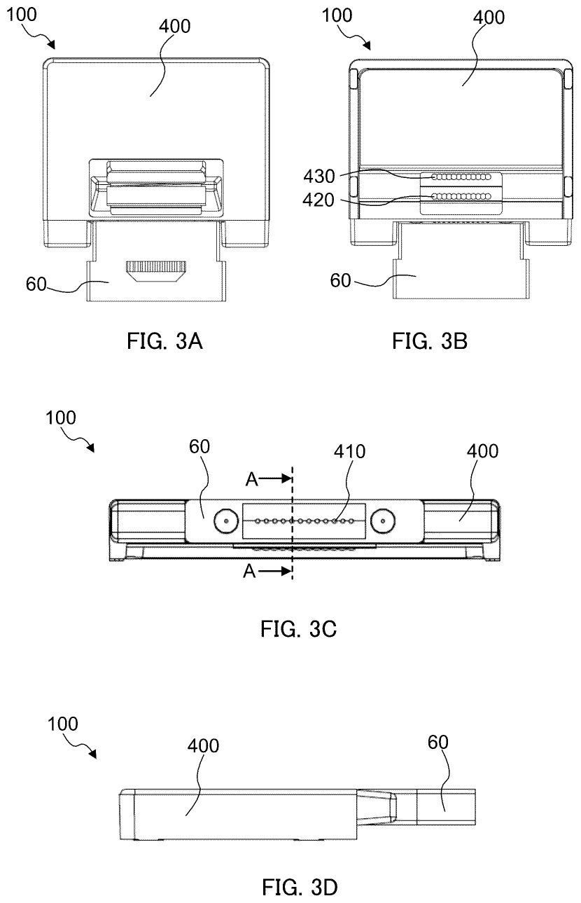

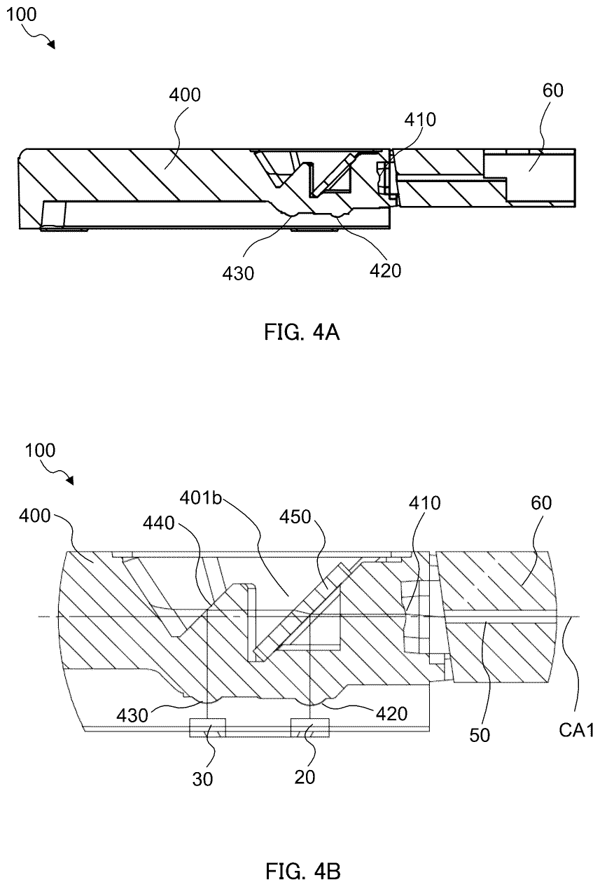

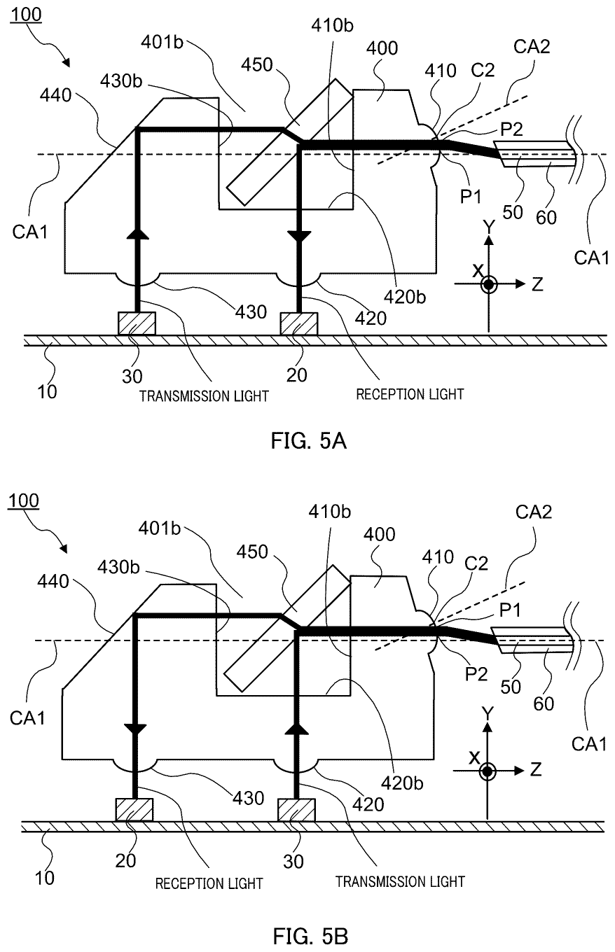

FIG. 3A is a plan view, FIG. 3B is a bottom view, FIG. 3C is a front view, and FIG. 3D is a side view each illustrating optical module 100 according to Embodiment 1 of the present invention. FIG. 4A is a cross-sectional view taken along line A-A in FIG. 3C, and FIG. 4B is a partially enlarged view of FIG. 4A. FIGS. 5A and 5B are views for schematically describing optical paths in optical module 100, but do not represent actual scales or the like.

In FIGS. 3A to 3D and 4A, a light receiving element, a light emitting element, and an optical transmission body are not illustrated. On the other hand, FIGS. 4B, 5A, and 5B illustrate light receiving element 20, light emitting element 30, and optical transmission body 50, and also illustrate optical paths therebetween. As illustrated in FIGS. 3A to 5B, optical module 100 includes light receiving element 20 and light emitting element 30 disposed on substrate 10, optical transmission body 50, ferrule 60, and optical receptacle 400.

FIGS. 5A and 5B illustrate a case where dispositions of light receiving element 20 and light emitting element 30 on substrate 10 are different. FIG. 5A illustrates a case where on substrate 10, light receiving element 20 is closer to optical transmission body 50 than light emitting element 30 is. FIG. 5B illustrates a case where on substrate 10, light emitting element 30 is closer to optical transmission body 50 than light receiving element 20 is. Each of optical paths of the bidirectional communication according to aspects of FIGS. 5A and 5B is as follows.

That is, in FIG. 5A, in a cross section including central axis CA1 of an optical transmission body and parallel to an optical axis of light emitting element 30 (hereinafter, the cross section is also referred to as a “reference cross section”), the end surface of optical transmission body 50—the end surface facing first optical surface 410—is inclined with respect to a surface perpendicular to the central axis of optical transmission body 50. As a result, the reception light from the end surface of optical transmission body 50 is refracted and emitted. In the example illustrated in FIG. 5A, the end surface of optical transmission body 50 is inclined so as to approach optical receptacle 400 from the bottom to the top of the end surface (away from substrate 10). Accordingly, the reception light is refracted at the end surface of optical transmission body 50 so as to be emitted to travel toward the side above an extension line of the central axis of optical transmission body 50 (toward a side opposite to substrate 10). The reception light emitted as described above enters the inside of optical receptacle 400 while being refracted at first optical surface 410 of optical receptacle 400, is reflected at transmission reflection section 450, is emitted from optical receptacle 400 through second optical surface 420, and reaches light receiving element 20. In FIGS. 5A and 5B, when an axis parallel to central axis CA1 of optical transmission body 50 is referred to as the Z-axis, the reference cross section is a surface parallel to the YZ plane in the XYZ coordinate consisting of the X-axis, the Y-axis, and the Z-axis, which are orthogonal to each other. Further, in the present specification, the term “the optical axis of light emitting element 30” means the central light ray of the three-dimensional emitted light flux from light emitting element 30.

On the other hand, the transmission light emitted from light emitting element 30 enters the inside of optical receptacle 400 from third optical surface 430 of optical receptacle 400, is reflected by reflection section 440, passes through transmission reflection section 450 while being refracted, is emitted from optical receptacle 400 while being refracted at first optical surface 410, and reaches the end surface of optical transmission body 50. At this time, at first optical surface 410, the transmission light is refracted and emitted to travel from a position above the extension line of the central axis of optical transmission body 50 toward the extension line side (lower side) of the central axis of optical transmission body 50.

Also in FIG. 5B, the end surface of optical transmission body 50 is inclined in the same manner, and the reception light from the end surface of optical transmission body 50 is refracted and emitted. As described above, the reception light is refracted at the end surface of optical transmission body 50 so as to be emitted to travel toward the side above an extension line of the central axis of optical transmission body 50 (toward a side opposite to substrate 10). The reception light emitted as described above enters the inside of optical receptacle 400 while being refracted at first optical surface 410 of optical receptacle 400, passes through transmission reflection section 450 while being refracted, is reflected by reflection section 440, is emitted from optical receptacle 400 through third optical surface 430, and reaches light receiving element 20.

On the other hand, the transmission light emitted from light emitting element 30 enters the inside of optical receptacle 400 from second optical surface 420, is reflected by transmission reflection section 450, is emitted from optical receptacle 400 while being refracted at first optical surface 410, and reaches the end surface of optical transmission body 50. Also at this time, at first optical surface 410, the transmission light is refracted and emitted to travel from a position above the extension line of the central axis of optical transmission body 50 toward the extension line side (lower side) of the central axis of optical transmission body 50.

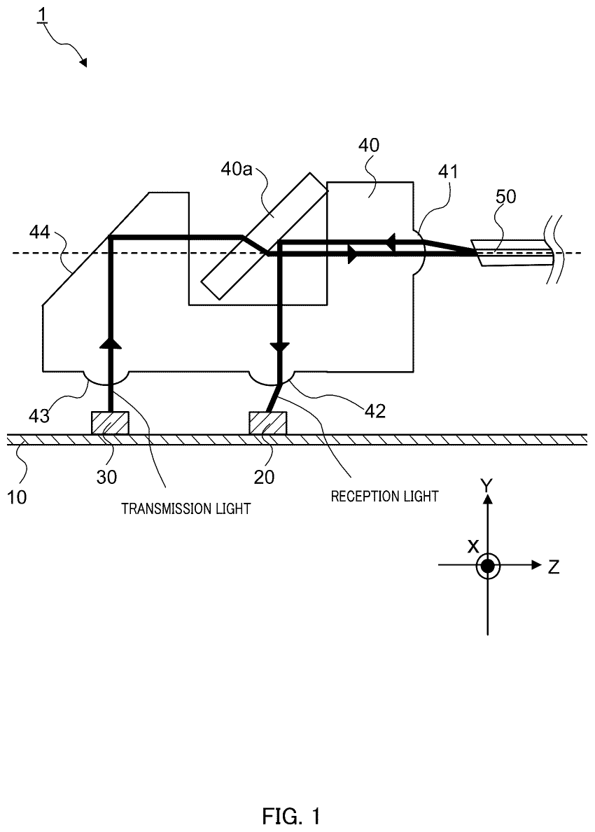

Here, in optical module 100 illustrated in FIGS. 5A and 5B, the optical paths become as follows, and therefore the tolerance range can be prevented from being biased as compared to the case in FIG. 1. That is, as can be understood in FIGS. 5A, 5B, and 1, as compared to an optical module for comparison (configured such that the optical axis of the light emitted from first optical surface 41 coincides with the central axis of optical transmission body 50, see FIG. 1), a principal ray of the reception light and a principal ray of the transmission light between transmission reflection section 450 and first optical surface 410 are located close to each other in a direction along an optical path between second optical surface 420 and transmission reflection section 450 (hereinafter, this will also be referred to as optical path condition 1).

Optical path condition 1 can be expressed as follows. That is, when the principal ray of the reception light and the principal ray of the transmission light between transmission reflection section 450 and first optical surface 410 are projected onto the above-described reference cross section, the principal ray of the reception light and the principal ray of the transmission light in optical module 100 according to the present invention are located closer to each other than the principal ray of the reception light and the principal ray of the transmission light in optical module 1 for comparison are.

Further, when a first intersection point is defined as an intersection point between the principal ray of the reception light and the first optical surface, and a second intersection point is defined as an intersection point between the principal ray of the transmission light and the first optical surface, the following can be understood in FIGS. 5A and 5B. When the principal ray of the reception light, the principal ray of the transmission light, first intersection point P1, and second intersection point P2 are projected onto the reference cross section, first intersection point P1 and second intersection point P2 are located in the same region among two regions separated from each other by an extension line of a central axis of the optical transmission body, and the first optical surface refracts the principal ray of the reception light and the principal ray of the transmission light such that the principal rays approach the extension line of the central axis of the optical transmission body (hereinafter, this is also referred to as optical path condition 2). Further, in the present embodiment, the reference cross section includes an optical path between the first optical surface and the transmission reflection section, and an optical path between the second optical surface and the transmission reflection section. The case where the principal rays and the intersection points are projected onto the reference cross section includes a case where the principal ray of the reception light and the principal ray of the transmission light are on the reference cross section. Further, examples of a case where the principal ray of the reception light and/or the principal ray of the transmission light are not on the reference cross section include an optical module in Embodiment 3 described below. By satisfying optical path conditions 1 and 2, the tolerance range is prevented from being biased. Details will be described below.

It is more preferable that the principal ray of the reception light and the principal ray of the transmission light are as follows. That is, between first optical surface 410 and transmission reflection section 450, it is preferable that the principal ray of the reception light and the principal ray of the transmission light overlap with each other, as illustrated in FIGS. 5A and 5B. As illustrated in FIGS. 5A and 5B, it is preferable that the principal ray of the reception light and the principal ray of the transmission light between first optical surface 410 and transmission reflection section 450 are parallel to a bottom surface of optical receptacle 400. As a result, the tolerance range is further prevented from being biased.

Hereinafter, each configuration provided in optical module 100 according to Embodiment 1 will be described.

### (Substrate)

Substrate 10 is not limited as long as light receiving element 20 and light emitting element 30 can be disposed thereon. Examples of substrate 10 include a glass composite substrate, a glass epoxy substrate, a flexible substrate, and the like.

### (Light Receiving Element and Light Emitting Element)

Light receiving element 20 is not limited as long as the light receiving element can receive light (reception light). The number of light receiving elements 20 may be one or more. In the present embodiment, plurality (for example, 12) of light receiving elements 20 are provided and are arranged in one row in the X direction. Examples of light receiving element 20 include a photodiode and the like. Light emitting element 30 is not limited as long as the light emitting element can emit light (transmission light). The number of light emitting elements 30 may be one or more. In the present embodiment, plurality (for example, 12) of light emitting element 30 are provided and are arranged in one row in the X direction. Further, examples of light emitting element 30 include a VCSEL or the like.

All light receiving elements 20 do not have to be arranged in one row, and all light emitting elements 30 do not have to be arranged in one row. For example, in one optical module 100, the following configuration is possible: four light receiving elements 20 and four light emitting elements 30 are disposed to face four second optical surfaces 420 and four third optical surfaces 430, respectively, as illustrated in FIG. 5A, and the other four light receiving elements 20 and the other four light emitting elements 30 are disposed to face the other four third optical surfaces 430 and the other four second optical surfaces 420, respectively, as illustrated in FIG. 5B. That is, four light receiving elements 20 and four light emitting elements 30 may be arranged in one row in the X direction to face plurality of second optical surfaces 420, and the other four light emitting elements 30 and other four light receiving elements 20 may be arranged in one row in the X direction to face plurality of third optical surfaces 430.

### (Optical Transmission Body)

A type of optical transmission body 50 is not limited. Examples of the type of optical transmission body 50 include an optical fiber and an optical waveguide. The number of optical transmission body 50 may be one or more corresponding to the numbers of light receiving elements 20 and light emitting elements 30. In the present embodiment, the number of optical transmission bodies 50 is more than one (for example, 12) to correspond to the numbers of light receiving element 20 and light emitting element 30, and optical transmission bodies are arranged in one row in the X direction. As described above, in the above-described reference cross section, the end surface of optical transmission body 50—the end surface facing first optical surface 410—is inclined with respect to a surface perpendicular to the central axis of optical transmission body 50. In the examples illustrated in FIGS. 5A and 5B, the end surface of optical transmission body 50 is inclined so as to approach optical receptacle 400 from the bottom to the top of the end surface (away from substrate 10).

### (Ferrule)

Ferrule 60 is a member that holds an end portions of optical transmission bodies 50 and performs position determination with respect to optical receptacle 400. In the present embodiment, ferrule 60 is attached to optical receptacle 400 by a guide pin or the like, so that the end surfaces of optical transmission bodies 50 are aligned with respect to first optical surfaces 410.

### (Optical Receptacle)

Hereinafter, a configuration of optical receptacle 400 provided in optical module 100 will be described.

Optical receptacle 400 includes first optical surfaces 410, second optical surfaces 420, third optical surfaces 430, reflection section 440, and transmission reflection section 450.

Optical receptacle 400 is formed by using a material that allows transmission of light (transmission light and reception light) of a wavelength used in optical communication. Examples of such materials include transparent resins such as polyetherimide (PEI) or a cyclic olefin resin. Further, optical receptacle 400 is manufactured by, for example, injection molding. Hereinafter, each component provided in optical receptacle 400 will be described.

### <First Optical Surface>

First optical surface 410 is a surface facing the end surface of optical transmission body 50. First optical surface 410 allows the reception light from the end surface of optical transmission body 50 to enter the inside of optical receptacle 400, and emits the transmission light that has passed through the inside of optical receptacle 400 toward the end surface of optical transmission body 50.

In the present embodiment, first optical surface 410 is configured to control the reception light and the transmission light such that the above-described optical path conditions 1 and 2 are satisfied. As a result, the tolerance range of optical receptacle 400 is prevented from being biased.

In the present embodiment, first optical surface 410 is a convex lens surface, and center C2 thereof is located at a position such that, in the reference cross section, center C2 does not overlap with an extension line of central axis CA1 of optical transmission body 50 as illustrated in FIGS. 5A and 5B. In the example illustrated in FIGS. 5A and 5B, center C2 of first optical surface 410 is located on the side above an extension line of the central axis of optical transmission body 50 (a side opposite to substrate 10). Further, central axis CA2 of first optical surface 410 is inclined such that central axis CA2 approaches the extension line of central axis CA1 of optical transmission body 50 as central axis CA2 approaches transmission reflection section 450.

### <Second Optical Surface>

Second optical surface 420 is a surface disposed at a position closer to first optical surface 410 than third optical surface 430 is and facing light receiving element 20 (see FIG. 5A) or facing light emitting element 30 (see FIG. 5B). In the present embodiment, second optical surface 420 is a convex lens surface that is convex toward light receiving element 20 or light emitting element 30. Second optical surface 420 allows the reception light that has passed through the inside of optical receptacle 400 to be emitted toward light receiving element 20 (see FIG. 5A), or allows the transmission light from light emitting element 30 to enter the inside of optical receptacle 400 (see FIG. 5B). In the present embodiment, the reception light that has passed through the inside of optical receptacle 400 is parallel light, and second optical surface 420 converges the parallel light and allows the converged light to reach light receiving element 20 (see FIG. 5A). Alternatively, in the present embodiment, second optical surface 420 converts light radially emitted from light emitting element 30 into parallel light and allows the parallel light to enter the inside of optical receptacle 400 (see FIG. 5B).

### <Third Optical Surface>

Third optical surface 430 is a surface disposed at a position farther from first optical surface 410 than second optical surface 420 is and facing light emitting element 30 (see FIG. 5A) or facing light receiving element 20 (see FIG. 5B). In the present embodiment, third optical surface 430 is a convex lens surface that is convex toward light emitting element 30 or light receiving element 20. Third optical surface 430 allows the transmission light from light emitting element 30 to enter the inside of optical receptacle 400 (see FIG. 5A), or emits the reception light that has passed through the inside of optical receptacle 400 toward light receiving element 20 (see FIG. 5B). In the present embodiment, third optical surface 430 converts light radially emitted from light emitting element 30 into parallel light and allows the parallel light to enter the inside of optical receptacle 400 (see FIG. 5A). Alternatively, in the present embodiment, the reception light that has passed through the inside of optical receptacle 400 is parallel light, and third optical surface 430 converges the parallel light and allows the converged light to reach light receiving element 20 (see FIG. 5B).

### <Transmission Reflection Section>

Transmission reflection section 450 reflects the reception light incident on first optical surface 410 toward second optical surface 420 and transmits the transmission light having entered the inside of optical receptacle 400 through third optical surface 430 (see FIG. 5A), or reflects the transmission light having entered the inside of optical receptacle 400 through second optical surface 420 toward first optical surface 410 and transmits the reception light incident on first optical surface 410 (see FIG. 5B). Transmission reflection section 450 has a function of reflecting one of reception light and transmission light having wavelengths different from each other and transmitting the other one of the reception light and the transmission light. Examples of such transmission reflection section 450 include wavelength separation filters. A wavelength separation filter is, for example, glass coated with a multi-layer film.

As illustrated in FIGS. 5A and 5B, in the present embodiment, transmission reflection section 450 is disposed in rectangular recess portion 401b provided to be recessed from a top surface side of optical receptacle 400. Recess portion 401b serves to temporarily extract the reception light and the transmission light to the outside of optical receptacle 400 and to cause the light to reach transmission reflection section 450, thereby controlling the optical path.

An inner surface of recess portion 401b includes a transmission surface. Specifically, the inner surface of recess portion 401b includes first transmission surface 410b located on a side opposite to first optical surface 410, second transmission surface 420b located on a side opposite to second optical surface 420, and third transmission surface 430b located on a side opposite to reflection section 440.

In the example illustrated in FIG. 5A, the reception light having entered the inside of optical receptacle 400 through first optical surface 410 passes through first transmission surface 410b to enter recess portion 401b, and is reflected by transmission reflection section 450. The reflected reception light passes through second transmission surface 420b to enter the inside of optical receptacle 400 and is emitted from optical receptacle 400 through second optical surface 420. On the other hand, the transmission light having entered the inside of optical receptacle 400 through third optical surface 430 is reflected by reflection section 440, passes through third transmission surface 430b to enter recess portion 401b, passes through transmission reflection section 450 while being refracted, passes through first transmission surface 410b to enter the inside of optical receptacle 400, and is emitted from optical receptacle 400 through first optical surface 410.

In the example illustrated in FIG. 5B, the reception light having entered the inside of optical receptacle 400 through first optical surface 410 passes through first transmission surface 410b to enter recess portion 401b, passes through transmission reflection section 450 while being refracted, passes through third transmission surface 430b to enter the inside of optical receptacle 400. The reception light having entered optical receptacle 400 is reflected by reflection section 440 and is emitted from optical receptacle 400 through third optical surface 430. On the other hand, the transmission light having entered the inside of optical receptacle 400 through second optical surface 420 passes through second transmission surface 420b to enter recess portion 401b, is reflected by transmission reflection section 450, and passes through first transmission surface 410b to enter the inside of optical receptacle 400. The transmission light having entered the inside of optical receptacle 400 is emitted from optical receptacle 400 through first optical surface 410.

Transmission reflection section 450 is preferably configured to satisfy optical path conditions 1 and 2 as illustrated in FIGS. 5A and 5B described above. Specifically, for example, the thickness of transmission reflection section 450 is appropriately designed so that optical paths of the reception light and the transmission light become as illustrated in FIGS. 5A and 5B.

### <Reflection Section>

Reflection section 440 is disposed on an optical path between third optical surface 430 and transmission reflection section 450, reflects the transmission light from third optical surface 430 toward transmission reflection section 450 (see FIG. 5A), or reflects the reception light from transmission reflection section 450 toward third optical surface 430 (see FIG. 5B). Reflection section 440 is not limited as long as the above-described function can be exhibited. In the present embodiment, reflection section 440 is a flat surface (inclined surface) that is inclined at an angle of 45° with respect to the bottom surface of optical receptacle 400.

### (Simulation)

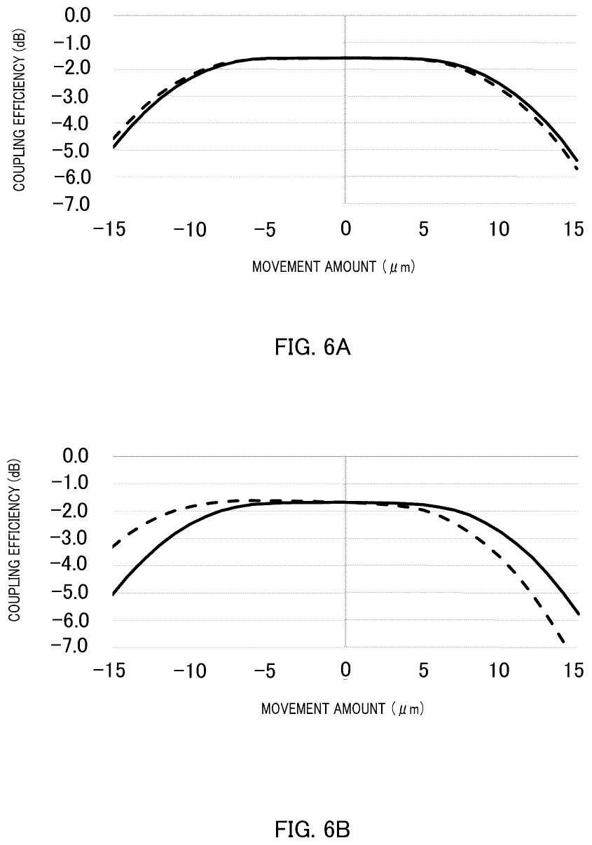

FIG. 6A is a graph illustrating a change in the coupling efficiency of the reception light when the center of light receiving element 20 is moved in the Z direction and the Y direction with respect to the center of second optical surface 420, in optical module 100 according to Embodiment 1 illustrated in FIG. 5A. In FIG. 6A, a solid line indicates a case where the center of light receiving element 20 is moved in the Z direction, and a dashed line indicates a case where the center of light receiving element 20 is moved in the Y direction. Similarly, FIG. 6B is a graph illustrating a change in the coupling efficiency of the reception light when the center of light receiving element 20 is moved in the Z direction and the Y direction with respect to the center of second optical surface 42, in optical module 1 of the comparative example illustrated in FIG. 1. In FIG. 6B, a solid line indicates a case where the center of light receiving element 20 is moved in the Z direction, and a dashed line indicates a case where the center of light receiving element 20 is moved in the Y direction.

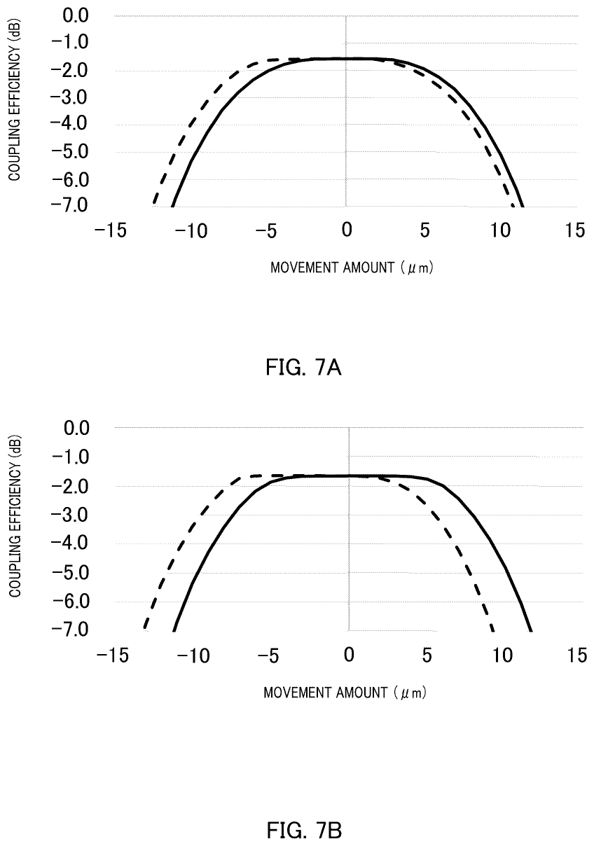

On the other hand, FIG. 7A is a graph illustrating a change in the coupling efficiency of the transmission light when the center of light emitting element 30 is moved in the Z direction and the Y direction with respect to the center of third optical surface 430, in optical module 100 according to Embodiment 1 illustrated in FIG. 5A. In FIG. 7A, a solid line indicates a case where the center of light emitting element 30 is moved in the Z direction, and a dashed line indicates a case where the center of light emitting element 30 is moved in the Y direction. Similarly, FIG. 7B is a graph illustrating a change in the coupling efficiency of the reception light when the center of light emitting element 30 is moved in the Z direction and the Y direction with respect to the center of third optical surface 430, in optical module 1 of the comparative example illustrated in FIG. 1. In FIG. 7B, a solid line indicates a case where the center of light emitting element 30 is moved in the Z direction, and a dashed line indicates a case where the center of light emitting element 30 is moved in the Y direction.

In FIGS. 6A and 6B, the point at which the movement amount is 0 μm indicates a case where the center of light receiving element 20 and the center of second optical surface 420 coincide with each other when viewed from the Y direction. Similarly, in FIGS. 7A and 7B, the point at which the movement amount is 0 μm indicates a case where the center of light emitting element 30 and the center of the third optical surface coincide with each other when viewed from the Y direction.

As can be understood from comparison between FIGS. 6A and 6B and comparison between FIGS. 7A and 7B, in optical module 100 according to the present embodiment, a line where the amount of movement is 0 μm and the center (tolerance center) of the linear portion where the coupling efficiency does not change are closer to each other than those in optical module 1 according to the comparative example. That is, in optical module 100 according to the present embodiment, the tolerance range is prevented from being biased. Specifically, in the examples illustrated in FIGS. 6A to 7B, a bias (vulnerability to a position deviation in the + direction) in the tolerance range, in which the coupling efficiency rapidly decreases when each of light receiving element 20 and light emitting element 30 is moved to the + direction to some extent, is reduced. This is because, in optical module 100, as illustrated in FIG. 5A in comparison with FIG. 1, optical path conditions 1 and 2 are satisfied.

### (Effect)

With optical module 100 according to the present embodiment, the tolerance range is prevented from being biased by satisfying optical path conditions 1 and 2.

### OTHER EMBODIMENTS

Hereinafter, Embodiments 2 to 5 that satisfy optical path conditions 1 and 2 in the same manner as that in Embodiment 1 will be described. Embodiments 2 to 5 will be mainly described in terms of points different from those in Embodiment 1. For Embodiments 2 to 5, configurations similar to those in Embodiment 1 are denoted with the same reference numerals, and descriptions will be omitted.

### Embodiment 2

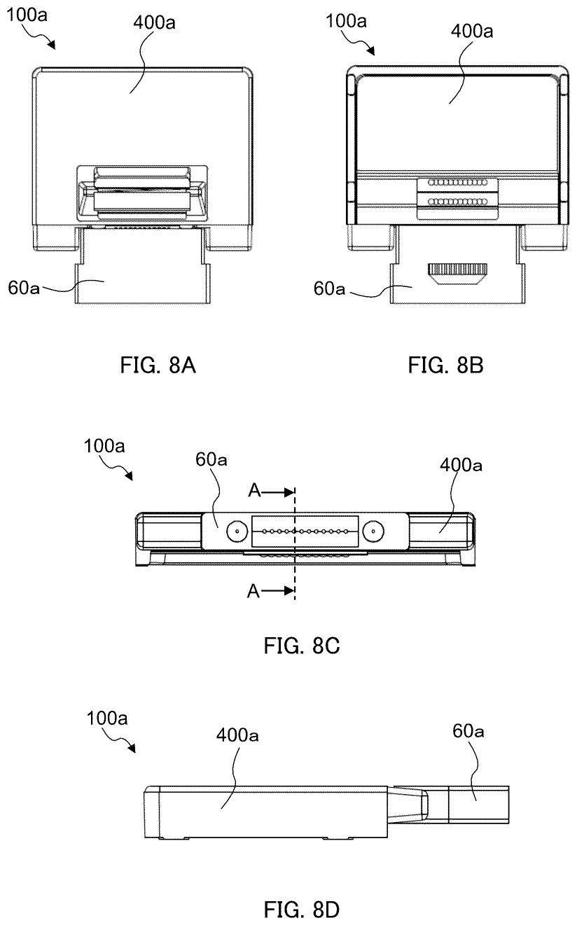

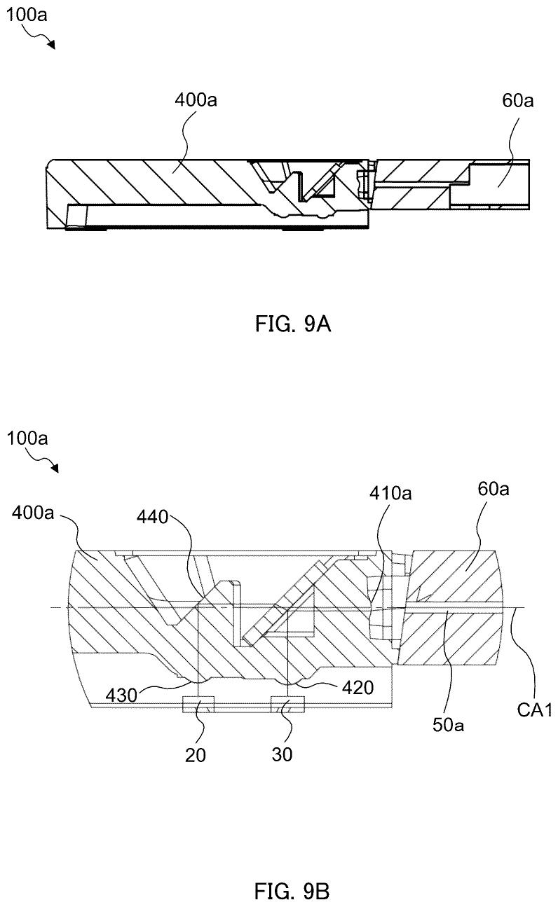

FIG. 8A is a plan view, FIG. 8B is a bottom view, FIG. 8C is a front view, and FIG. 8D is a side view each illustrating optical module 100a according to Embodiment 2 of the present invention. FIG. 9A is a cross-sectional view taken along line A-A in FIG. 8C, and FIG. 9B is a partially enlarged view of FIG. 9A.

In optical module 100a, an inclination direction of an end surface of optical transmission body 50a is different from that of optical module 100 according to Embodiment 1. In accordance with this, a position and the inclination direction of first optical surface 410a in optical module 100a are different from those in Embodiment 1. Specifically, as illustrated in FIG. 9B, in optical module 100a, the end surface of optical transmission body 50a is inclined such that the end surface approaches optical receptacle 400a from the top to the bottom of the end surface (approaching substrate 10). Accordingly, the reception light is refracted at the end surface of optical transmission body 50a so as to be emitted to travel toward the side below an extension line of central axis CA1 of optical transmission body 50a (toward the substrate 10 side) (see the comparison between FIGS. 9B and 4B). In the present embodiment, the center of first optical surface 410a is located on the side below the extension line of central axis CA1 of optical transmission body 50a (on the substrate 10 side). Further, the central axis of first optical surface 410a is inclined such that the central axis approaches the extension line of central axis CA1 of optical transmission body 50a as the central axis approaches transmission reflection section 450. As described above, optical receptacle 400a provided in optical module 100a only needs to be configured so as to satisfy optical path conditions 1 and 2 for the reception light refracted downward at the end surface of optical transmission body 50a. That is, in a cross section including the optical path in optical module 100a, optical path conditions 1 and 2 are satisfied in a region on the lower side in the two regions separated from each other by the extension line of central axis CA1 of optical transmission body 50, as illustrated in FIG. 9B. In Embodiment 1, optical path conditions 1 and 2 are satisfied in a region on the upper side of the two regions separated from each other. As a result, in Embodiment 2, the tolerance range is prevented from being biased in the same manner as that in Embodiment 1 (see the comparison between FIGS. 9B and 4B).

### (Effect)

Optical module 100a according to Embodiment 2 has the same effects as those of optical module 100 according to Embodiment 1.

### Embodiment 3

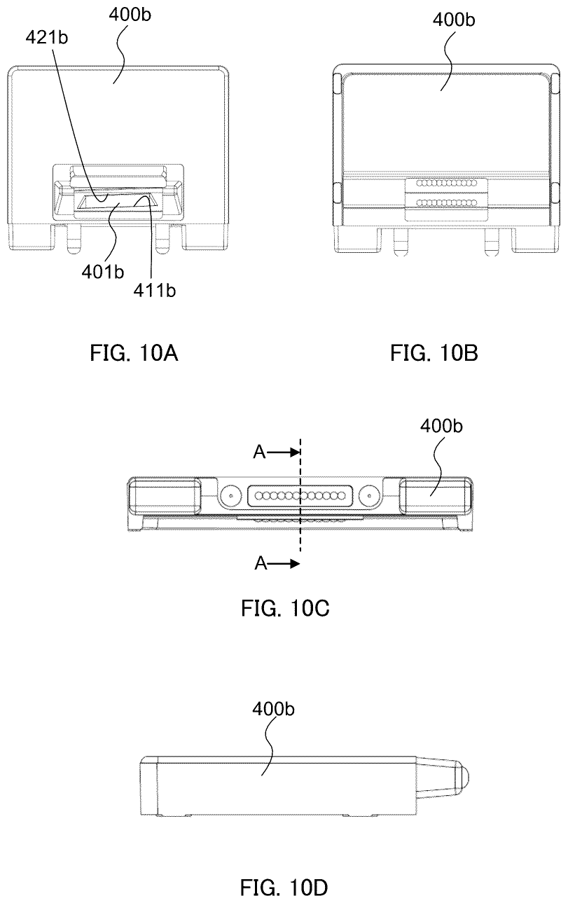

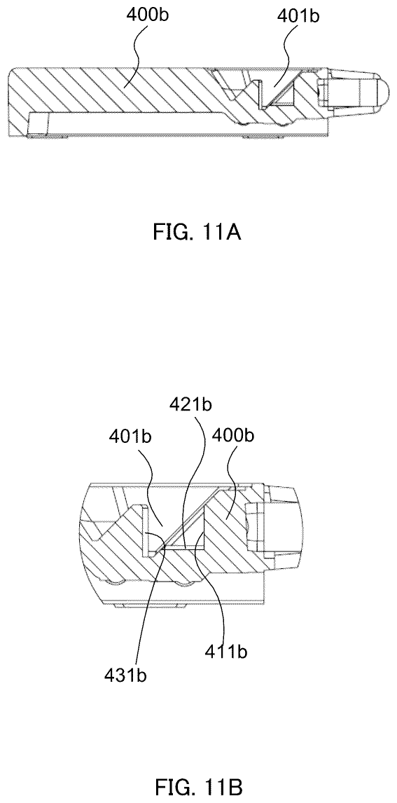

FIG. 10A is a plan view, FIG. 10B is a bottom view, FIG. 10C is a front view, and FIG. 10D is a side view each illustrating optical receptacle 400b according to Embodiment 3 of the present invention. FIG. 11A is a cross-sectional view taken along line A-A in FIG. 10C, and FIG. 11B is a partially enlarged view of FIG. 11A.

Recess portion 401b provided in optical receptacle 400b is different from recess portion 401b provided in Embodiment 1 in that recess portion 401b has a configuration for suppressing returning light. Hereinafter, recess portion 401b will be described.

As illustrated in FIG. 11B, recess portion 401b includes first transmission surface 411b, second transmission surface 421b, and third transmission surface 431b. In recess portion 401b, as illustrated in FIG. 10A, first transmission surface 411b and second transmission surface 421b are inclined with respect to a perpendicular surface that is perpendicular to central axis CA1 of optical transmission body 50. Specifically, in the present embodiment, when optical receptacle 400b is viewed in plan view as illustrated in FIG. 10A, first transmission surface 411b is inclined such that one end is closer to a front surface of optical receptacle 400b and the other end is farther from the front surface. Similarly, second transmission surface 421b is inclined such that one end is closer to the front surface of optical receptacle 400b and the other end is farther from the front surface. In the present embodiment, first transmission surface 411b and second transmission surface 421b are parallel to each other. In this manner, by inclining first transmission surface 411b and second transmission surface 421b, the reception light and the transmission light do not pass perpendicularly through first transmission surface 411b and second transmission surface 421b. Specifically, in Embodiment 3, the reception light and the transmission light that have passes through first transmission surface 411b and/or second transmission surface 421b are refracted so as to travel away from or approach the above-described reference cross section (refract in the X direction in FIGS. 5A and 5B). This prevent the reception light and the transmission light from being reflected by first transmission surface 411b and second transmission surface 421b and returning, that is so-called returning light. An inclination angle only needs to be set as appropriate from the viewpoint of preventing returning light.

### (Effect)

Optical receptacle 400b according to Embodiment 3 has an effect of preventing the tolerance range from being biased in the same manner as that in Embodiment 1. Further, optical receptacle 400b according to Embodiment 3 has an effect of preventing returning light.

### Embodiment 4

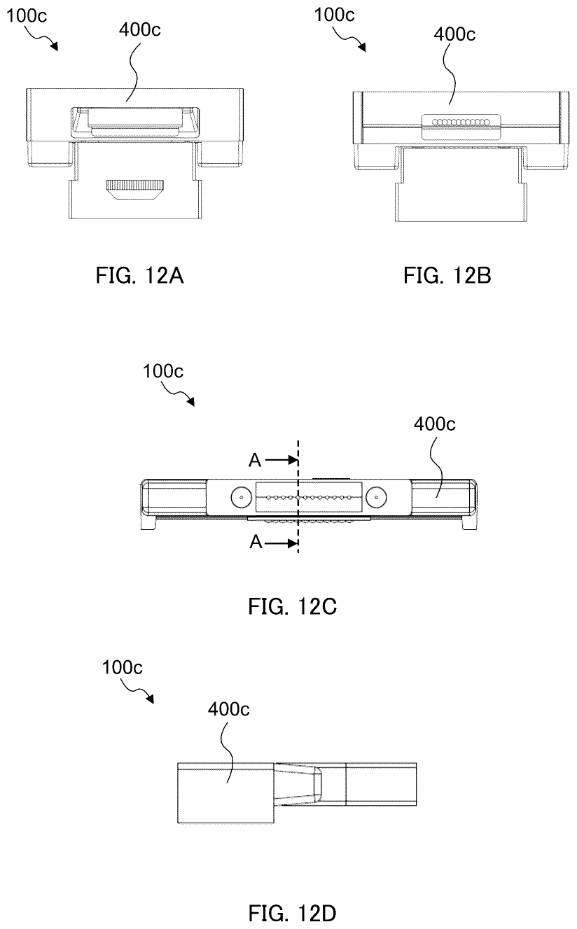

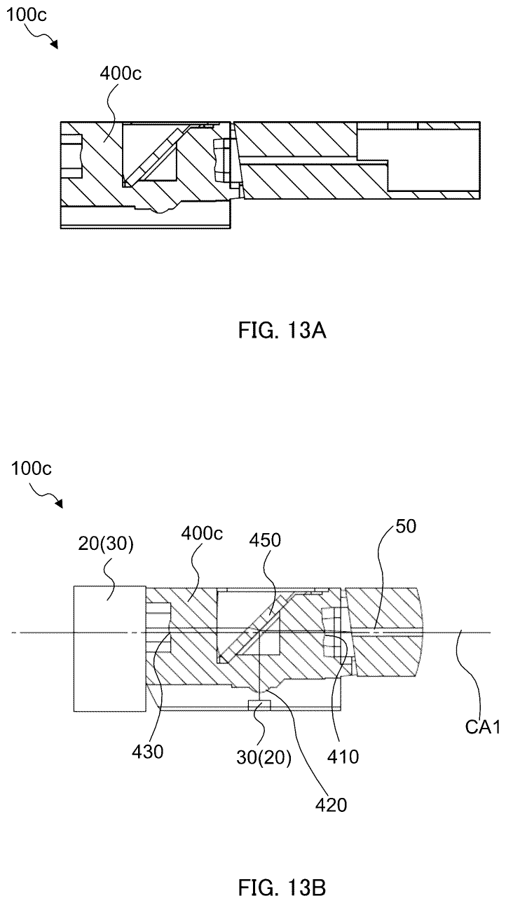

FIG. 12A is a plan view, FIG. 12B is a bottom view, FIG. 12C is a front view, and FIG. 12D is a side view each illustrating optical module 100c according to Embodiment 4 of the present invention. FIG. 13A is a cross-sectional view taken along line A-A in FIG. 12C, and FIG. 13B is a partially enlarged view of FIG. 13A.

Optical module 100c according to Embodiment 4 includes optical receptacle 400c. As illustrated in FIG. 13A, optical receptacle 400c is different from optical receptacle 400 according to Embodiment 1 in that optical receptacle 400c does not include a reflection section and includes third optical surface 430 on the rear surface of optical receptacle 400c.

In optical module 100c according to Embodiment 4, when third optical surface 430 faces light receiving element 20, the reception light from optical transmission body 50 enters the inside of optical receptacle 400c from first optical surface 410, passes through transmission reflection section 450, and is emitted from third optical surface 430 toward light receiving element 20, as illustrated in FIG. 13B. On the other hand, when third optical surface 430 faces light emitting element 30, the transmission light from light emitting element 30 enters from third optical surface 430, passes through transmission reflection section 450, and is emitted from first optical surface 410 toward the end surface of optical transmission body 50.

### (Effect)

Optical module 100c according to Embodiment 4 has an effect of preventing the tolerance range from being biased in the same manner as that in Embodiment 1.

### Embodiment 5

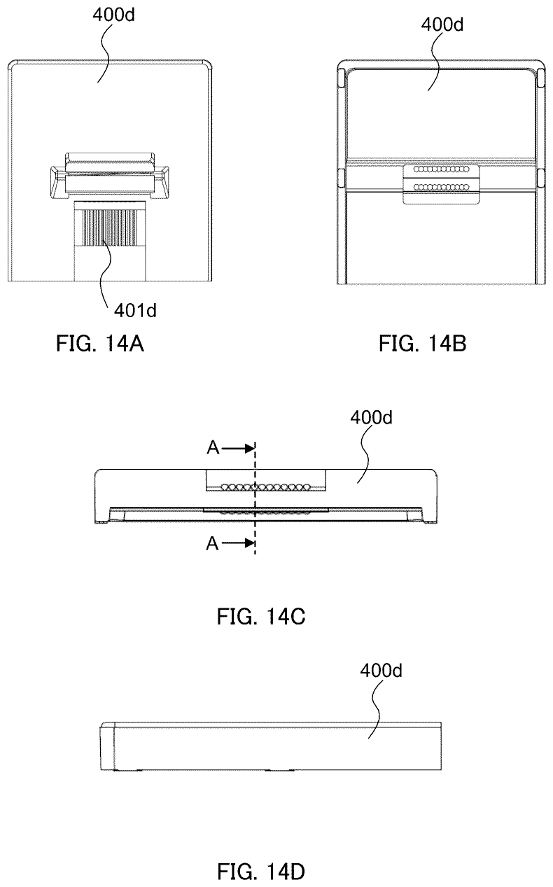

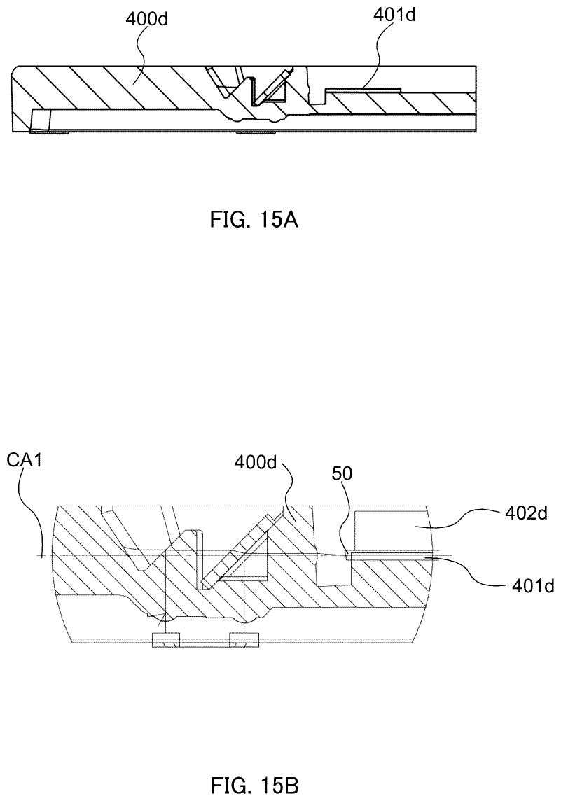

FIG. 14A is a plan view, FIG. 14B is a bottom view, FIG. 14C is a rear view, and FIG. 14D is a side view each illustrating optical receptacle 400d according to Embodiment 5 of the present invention. FIG. 15A is a cross-sectional view taken along line A-A in FIG. 14C. FIG. 15B is a partially enlarged view of FIG. 15A.

Optical receptacle 400d is different from optical receptacle 400 according to Embodiment 1 in that optical receptacle 400d includes grooves 401d for holding optical transmission bodies 50 instead of ferrule 60. In the present embodiment, plurality of grooves 401d are provided and each extend in a direction from the front surface to the rear surface of optical receptacle 400d. As illustrated in FIG. 15B, optical transmission bodies 50 disposed in grooves 401d are pressed by lid 402d.

### (Effect)

Optical module 100d according to Embodiment 5 has an effect of preventing the tolerance range from being biased in the same manner as that in Embodiment 1. Further, in optical module 100d according to Embodiment 5, optical transmission bodies 50 can be held by grooves 401d.

### INDUSTRIAL APPLICABILITY

The optical module and the optical receptacle according to the present invention are useful for optical communication using, for example, an optical transmission body.

### REFERENCE SIGNS LIST

1, 100, 100a, 100c, 100d Optical module
10 Substrate
20 Light receiving element
30 Light emitting element
40, 400, 400a, 400b, 400c, 400d Optical receptacle
40a, 450 Transmission reflection section
41, 410, 410a First optical surface
42, 420 Second optical surface
43, 430 Third optical surface
44, 440 Reflection section
50, 50a Optical transmission body
60, 60a Ferrule
401b Recess portion
401d Groove
402d Lid
410b, 411b First transmission surface
420b, 421b Second transmission surface
430b, 431b Third transmission surface

1. An optical module comprising:
a light receiving element;
a light emitting element;
an optical transmission body; and
an optical receptacle for allowing reception light from an end surface of the optical transmission body to reach the light receiving element and for allowing transmission light from the light emitting element to reach the end surface of the optical transmission body,
wherein:
the optical receptacle includes
a first optical surface for allowing the reception light from the end surface of the optical transmission body to enter an inside of the optical receptacle and for emitting, toward the end surface of the optical transmission body, the transmission light having passed through the inside of the optical receptacle,
a second optical surface for emitting, toward the light receiving element, the reception light having passed through the inside of the optical receptacle, or for allowing the transmission light from the light emitting element to enter the inside of the optical receptacle,
a third optical surface for allowing the transmission light from the light emitting element to enter the inside of the optical receptacle, or for emitting, toward the light receiving element, the reception light having passed through the inside of the optical receptacle, the third optical surface being disposed at a position farther from the first optical surface than the second optical surface is, and
a transmission reflection section for
reflecting, toward the second optical surface, the reception light having entered the inside of the optical receptacle through the first optical surface, and transmitting the transmission light having entered the inside of the optical receptacle through the third optical surface, or
reflecting, toward the first optical surface, the transmission light having entered the inside of the optical receptacle through the second optical surface, and transmitting the reception light having entered the inside of the optical receptacle through the first optical surface,
in a cross section including a central axis of the optical transmission body and parallel to an optical axis of the light emitting element, an end surface of the optical transmission body is inclined with respect to a surface perpendicular to the central axis of the optical transmission body, and wherein the end surface faces the first optical surface,
in the optical module, a principal ray of the reception light and a principal ray of the transmission light between the transmission reflection section and the first optical surface are located close to each other in a direction along an optical path between the second optical surface and the transmission reflection section, as compared to an optical module for comparison configured such that an optical axis of light emitted from the first optical surface coincides with the central axis of the optical transmission body, and
when a first intersection point is defined as an intersection point between the principal ray of the reception light and the first optical surface, a second intersection point is defined as an intersection point between the principal ray of the transmission light and the first optical surface, and the principal ray of the reception light, the principal ray of the transmission light, the first intersection point, and the second intersection point are projected onto the cross section,
the first intersection point and the second intersection point are located in one region among two regions separated from each other by an extension line of the central axis of the optical transmission body, and
the first optical surface refracts the principal ray of the reception light and the principal ray of the transmission light such that the principal rays approach the extension line of the central axis of the optical transmission body.

2. The optical module according to claim 1, wherein
the cross section includes an optical path between the first optical surface and the transmission reflection section and the optical path between the second optical surface and the transmission reflection section.

3. The optical module according to claim 1, wherein:
on the cross section, a center of the first optical surface is located at a position such that the center does not overlap with the extension line of the central axis of the optical transmission body; and
the central axis of the first optical surface is inclined such that the central axis approaches the extension line of the central axis of the optical transmission body as the central axis approaches the transmission reflection section.

4. The optical module according to claim 1, wherein
between the first optical surface and the transmission reflection section, the principal ray of the reception light and the principal ray of the transmission light overlap with each other.

5. The optical module according to claim 1, wherein
between the first optical surface and the transmission reflection section, the principal ray of the reception light and the principal ray of the transmission light are parallel to a bottom surface of the optical receptacle.

6. The optical module according to claim 1, wherein
the principal ray of the reception light or the transmission light between the second optical surface and the light receiving element or the light emitting element, and the principal ray of the transmission light or the reception light between the third optical surface and the light emitting element or the light receiving element are perpendicular to a bottom surface of the optical receptacle.

7. The optical module according to claim 1, further comprising:
a reflection section for reflecting, toward the transmission reflection section, the transmission light from the third optical surface, or for reflecting, toward the third optical surface, the reception light from the transmission reflection section, the reflection section being disposed on an optical path between the third optical surface and the transmission reflection section.

8. The optical receptacle used for the optical module according to claim 1.
